(19) United States
(12) Patent Application Publication
(10) Pub. No.: US 2025/0214539 A1
(43) Pub. Date: Jul. 3, 2025

(54) WINDSCREEN WIPER BLADE FOR A VEHICLE COMPRISING TWO CONNECTORS AND A SPRAYING DEVICE

(71) Applicant: VALEO SYSTEMES D'ESSUYAGE, La Verriere (FR)

(72) Inventors: Gerald CAILLOT, La Verriere (FR); Jean Michel JARASSON, La Verriere (FR); Vincent IZABEL, La Verriere (FR); Alexandre FILLOUX, La Verriere (FR)

(73) Assignee: VALEO SYSTEMES D'ESSUYAGE, La Verriere (FR)

(21) Appl. No.: 18/996,113

(22) PCT Filed: Jul. 21, 2023
(86) PCT No.: PCT/EP2023/070361

§ 371 Date: Jan. 17, 2025

(30) Foreign Application Priority Data
Jul. 21, 2022 (FR) 2207510

(51) Int. Cl. B60S 1/52; B60S 1/04

(52) U.S. Cl. CPC B60S 1/524; B60S 1/0408

(57) ABSTRACT

The invention relates to a windscreen wiper blade for a vehicle. The wiper blade at least one wiping strip configured to wipe a glazed surface of the vehicle, a stiffening member including a vertebra support and at least one vertebra configured to stiffen the wiping strip, a central mounting configured to be connected to a drive arm of the windscreen wiper blade, an air deflector connected to the vertebra support, two connectors rigidly connected to the at least one vertebra. The wiper blade also includes a spraying device configured to spray a washing fluid onto the glazed surface with spraying openings, and a washing-fluid distribution device configured to distribute washing fluid to the spraying device.

### TECHNICAL FIELD

The present invention relates to a windshield wiper for a vehicle. It is particularly applicable, but not limited, to automotive vehicles.

### BACKGROUND OF THE INVENTION

A person skilled in the art is familiar with a windshield wiper for a vehicle, comprising:
a wiper blade configured to wipe a glazed surface of the vehicle,
a stiffening member comprising a vertebra support and a vertebra,
two connectors secured to said vertebra,
a central mount articulated on each of the two connectors and configured to be fastened to a drive arm of the windshield wiper,
an air deflector connected to the vertebra support.

The windshield wiper carries out a function of wiping a glazed surface of the vehicle, such as a windshield. The air deflector makes it possible to improve the force with which the windshield wiper is pressed against the glazed surface of the vehicle. Furthermore, for washing the glazed surface with a washer fluid, the vehicle comprises a spray nozzle in the region of the hood, which sprays the washer fluid onto the glazed surface.

A drawback of this prior art is that when the curvature of the glazed surface to be cleaned is very pronounced, or when the glazed surface is panoramic, as in the case of a vehicle such as a truck or a bus, the washing of this type of glazed surface is not effective.

### SUMMARY OF THE INVENTION

In this context, the present invention aims to propose a windshield wiper for a vehicle that makes it possible to solve the abovementioned drawback.

To this end, the invention proposes a windshield wiper for a vehicle, said windshield wiper comprising:
at least one wiper blade configured to wipe a glazed surface of the vehicle,
a stiffening member comprising a vertebra support and at least one vertebra configured to stiffen said at least one wiper blade,
at least two connectors secured to said at least one vertebra,
a central mount articulated on each of the two connectors, the central mount being configured to be connected to a drive arm of the windshield wiper,
an air deflector connected to the vertebra support,
characterized in that the windshield wiper also comprises:
a spraying device configured to spray a washer fluid onto said glazed surface, said spraying device comprising spray orifices,
a distribution device for the washer fluid, configured to distribute said washer fluid to said spraying device.

Thus, as will be seen in detail below, using two connectors with a central mount in combination with an integrated spraying device makes it possible to better distribute the pressure force locally on the glazed surface and to better distribute the washer liquid to the glazed surface, and consequently to better wipe and wash the entire glazed surface.

According to nonlimiting embodiments, said windshield wiper may also have one or more of the following additional features, taken alone or in any technically possible combinations.

According to one nonlimiting embodiment, the spraying device is configured to spray washer fluid along the entire length of the windshield wiper.

According to one nonlimiting embodiment, said spraying device comprises at least one hydraulic manifold.

According to one nonlimiting embodiment, said at least one hydraulic manifold comprises spray orifices in at least one of its portions.

According to one nonlimiting embodiment, said distribution device comprises a supply pipe connected to at least one of the two connectors and the air deflector comprises the spraying device.

According to one nonlimiting embodiment, said supply pipe is connected to the two connectors via, respectively, two feed pipes for the washer fluid.

According to one nonlimiting embodiment, said supply pipe is connected directly to a single connector.

According to one nonlimiting embodiment, said at least one connector comprises at least one hydraulic channel for supplying at least one portion of said spraying device with washer fluid.

According to one nonlimiting embodiment, said at least one hydraulic manifold of the spraying device comprises spray orifices in two of its portions.

According to one nonlimiting embodiment, said distribution device comprises a supply pipe connected to said central mount.

According to one nonlimiting embodiment, said air deflector comprises the spraying device and said distribution device also comprises a feed pipe connected to said central mount and to at least one of the two connectors.

According to one nonlimiting embodiment, said central mount comprises all or part of the spraying device.

According to one nonlimiting embodiment, said air deflector comprises a part of the spraying device, and said spraying device comprises at least one primary hydraulic manifold that forms part of the central mount, and at least one secondary hydraulic manifold that forms part of the air deflector, and said distribution device also comprises a feed pipe connected to said central mount and to at least one of the two connectors.

According to one nonlimiting embodiment, at least one of the two connectors comprises a hydraulic channel for supplying said at least one secondary hydraulic manifold with washer fluid.

According to one nonlimiting embodiment, the central mount comprises an air deflecting surface.

According to one nonlimiting embodiment, the stiffening member comprises at least two vertebrae placed end to end via their longitudinal ends.

According to one nonlimiting embodiment, the two vertebrae have different lengths.

According to one nonlimiting embodiment, the two vertebrae have different radii of curvature.

According to one nonlimiting embodiment, each connector is positioned substantially at the center of each vertebra.

According to one nonlimiting embodiment, each connector is secured to a vertebra.

According to one nonlimiting embodiment, the two feed pipes are connected to a supply pipe via a hydraulic connector.

According to one nonlimiting embodiment, one of the two connectors does not have an inlet for washer fluid.

According to one nonlimiting embodiment, one of the two connectors also comprises a cannula configured to be closed with a plug.

According to one nonlimiting embodiment, the primary hydraulic manifold and the secondary hydraulic manifold extend on the same side of the windshield wiper.

According to one nonlimiting embodiment, the spraying device comprises two primary hydraulic manifolds and two secondary hydraulic manifolds.

According to one nonlimiting embodiment, the two primary hydraulic manifolds each extend along each side of the central mount.

According to one nonlimiting embodiment, the two secondary hydraulic manifolds each extend along each side of the air deflector.

According to one nonlimiting embodiment, the two primary and secondary hydraulic manifolds are activated alternately depending on the movement of the windshield wiper.

According to one nonlimiting embodiment, the spraying device comprises two hydraulic manifolds that form part of the air deflector.

According to one nonlimiting embodiment, the two hydraulic manifolds each extend along each side of the air deflector.

According to one nonlimiting embodiment, the two hydraulic manifolds are activated alternately depending on the movement of the windshield wiper.

According to one nonlimiting embodiment, the air deflector is made up of at least three parts.

According to one nonlimiting embodiment, the air deflector comprises a lower part, a central part, and an upper part.

According to one nonlimiting embodiment, the lower part extends from the lower end of the windshield wiper to a first connector, the central part is situated between the two connectors, and the upper part extends from the second connector to the upper end of the windshield wiper.

### BRIEF DESCRIPTION OF DRAWINGS

The invention and the various applications thereof will be understood better from reading the following description and examining the accompanying figures:

FIG. 1 is an exploded diagram of a windshield wiper comprising at least a wiper blade, a stiffening member with a vertebra support and a vertebra, a central mount, an air deflector, two connectors, and a washer fluid spraying device, according to a nonlimiting embodiment of the invention,

FIG. 2 is a cross-sectional view of a part of the windshield wiper in FIG. 1, according to a nonlimiting embodiment,

FIG. 3 is a perspective view of the windshield wiper in FIG. 1, according to a first embodiment variant of a first nonlimiting embodiment,

FIG. 4 is a close-up view of a part of the windshield wiper in FIG. 3, according to a nonlimiting embodiment,

FIG. 5 is a view of a first connector of the windshield wiper in FIG. 3, according to a nonlimiting embodiment,

FIG. 6 is a view of a second connector of the windshield wiper in FIG. 3, according to a nonlimiting embodiment,

FIG. 7 is a side view of a part of the air deflector of the windshield wiper in FIG. 3, comprising a lower portion of a hydraulic manifold of the spraying device, according to a nonlimiting embodiment,

FIG. 8 is a side view of a part of the air deflector of the windshield wiper in FIG. 3, comprising an upper portion of a hydraulic manifold of the spraying device of the windshield wiper in FIG. 3, according to a nonlimiting embodiment,

FIG. 9 is a side view of a part of the air deflector of the windshield wiper in FIG. 3, comprising a central portion of a hydraulic manifold of the spraying device of the windshield wiper in FIG. 3, according to a nonlimiting embodiment,

FIG. 10 is a perspective view of the windshield wiper in FIG. 1, according to a second embodiment variant of a first nonlimiting embodiment,

FIG. 11 is a view of a first connector of the windshield wiper in FIG. 10, according to a nonlimiting embodiment,

FIG. 12 is a view of a second connector of the windshield wiper in FIG. 10, according to a nonlimiting embodiment,

FIG. 13 is a perspective view of a part of the windshield wiper in FIG. 1, according to a first nonlimiting embodiment variant of a second nonlimiting embodiment,

FIG. 14 is a bottom view of the central mount of the windshield wiper in FIG. 13, according to a nonlimiting embodiment,

FIG. 15 is a first close-up view of a part of the windshield wiper in FIG. 13, according to a nonlimiting embodiment,

FIG. 16 is a second close-up view of a part of the windshield wiper in FIG. 13, according to a nonlimiting embodiment,

FIG. 17 is a bottom view of the central mount of the windshield wiper in FIG. 13, according to a nonlimiting embodiment,

FIG. 18 is a perspective view of a part of the air deflector of the windshield wiper in FIG. 13, according to a nonlimiting embodiment,

FIG. 19 is a perspective view of another part of the air deflector of the windshield wiper in FIG. 13, according to a nonlimiting embodiment,

FIG. 20 is a perspective view of a part of the windshield wiper in FIG. 1, according to a second nonlimiting embodiment variant of a second nonlimiting embodiment,

FIG. 21 is a close-up view of a part of the windshield wiper in FIG. 20, according to a nonlimiting embodiment,

FIG. 22 is a view of a first connector of the windshield wiper in FIG. 20, according to a nonlimiting embodiment,

FIG. 23 is a view in longitudinal section of the connector in FIG. 22, according to a nonlimiting embodiment,

FIG. 24 is a cross-sectional view of the connector in FIG. 22, according to a nonlimiting embodiment,

FIG. 25 is a close-up view of a lower part of the air deflector of the windshield wiper in FIG. 20, comprising a lower portion of a hydraulic manifold, according to a nonlimiting embodiment,

FIG. 26 is a close-up view of a lower part of the air deflector of the windshield wiper in FIG. 20, comprising an upper portion of a hydraulic manifold, according to a nonlimiting embodiment,

FIG. 27 is a close-up view of a part of the central mount and of the air deflector of the windshield wiper in FIG. 20, according to a nonlimiting embodiment,

FIG. 28 is a close-up view of a part of the central mount and of the air deflector of the windshield wiper in FIG. 20, according to a nonlimiting embodiment,

FIG. 29 is a perspective view of a part of the windshield wiper in FIG. 1, according to a third nonlimiting embodiment,

FIG. 30 is a first close-up view of a part of the windshield wiper in FIG. 29, according to a nonlimiting embodiment,

FIG. 31 is a second close-up view of a part of the windshield wiper in FIG. 29, according to a nonlimiting embodiment,

FIG. 32 is a close-up view of a lower part of the deflector of the windshield wiper in FIG. 29, comprising a lower portion of a hydraulic manifold, according to a nonlimiting embodiment,

FIG. 33 is a close-up view of a lower part of the deflector of the windshield wiper in FIG. 29, comprising an upper portion of a hydraulic manifold, according to a nonlimiting embodiment,

FIG. 34 is a perspective view of the central mount of the windshield wiper in FIG. 29, according to a nonlimiting embodiment.

### DETAILED DESCRIPTION OF THE INVENTION

Elements that are identical in terms of structure or function and that appear in different figures have been designated with the same reference signs, unless specified otherwise.

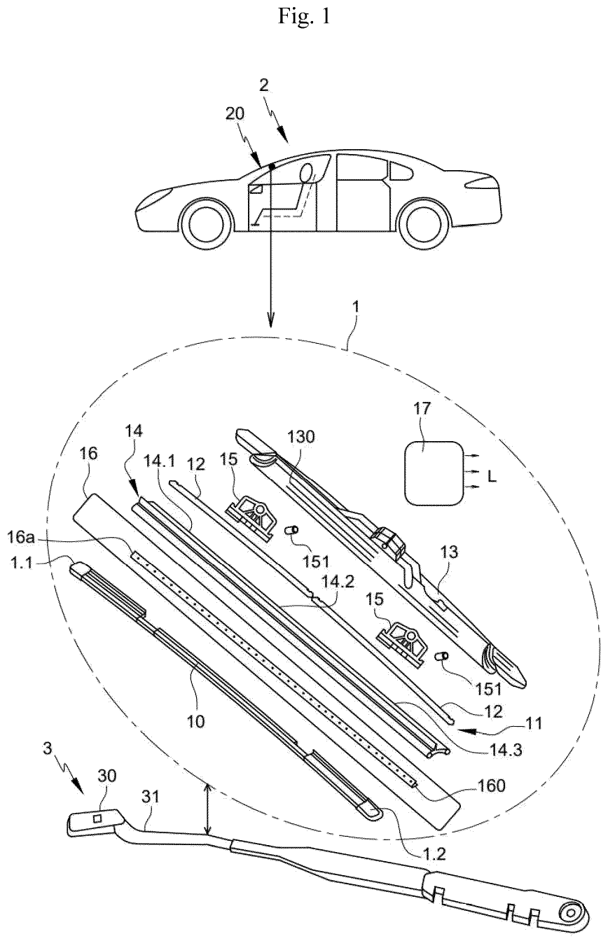

The windshield wiper 1 for a vehicle 2 according to the invention is described with reference to FIG. 1 to FIG. 34 according to nonlimiting embodiments. In one nonlimiting embodiment, the vehicle 2 is an automotive vehicle. An automotive vehicle is to be understood to mean any type of motorized vehicle. This embodiment given as a nonlimiting example in the remainder of the description. In the remainder of the description, the vehicle 2 is thus also referred to as an automotive vehicle 2.

In the following description, the terms “longitudinal” or “lateral” refer to the windshield wiper 1. The longitudinal direction corresponds to the main axis of the windshield wiper along which it extends, while the lateral orientations correspond to concurrent straight lines, that is to say straight lines which cross the longitudinal direction, in particular perpendicularly to the longitudinal axis of the windshield wiper 1 in the plane in which it rotates.

The automotive vehicle 2 comprises a glazed surface 20 that needs to be wiped and cleaned. In one nonlimiting embodiment, the glazed surface 20 is the windshield of the automotive vehicle 2.

FIG. 1 shows an exploded view of a windshield wiper 1. The windshield wiper 1 is a flat windshield wiper, also referred to as a “flat blade”.

The windshield wiper 1 comprises:
at least one wiper blade 10,
a stiffening member 11 comprising a vertebra support 12.1 and at least one vertebra 12,
two connectors 15 secured to said at least one vertebra 12,
a central mount 13 articulated on each of the two connectors 15,
an air deflector 14 connected to the vertebra support 12.1,
a spraying device 16, and
a distribution device 17 for a washer fluid L.

As illustrated in FIG. 1, the windshield wiper 1 is delimited by a lower end 1.1, also referred to as bottom end 1.1, and by an upper end 1.2, also referred to as top end 1.2. These two ends form the ends of the wiper blade 10. The ends 1.1 and 1.2 are end pieces which make it possible to secure the components 14 and 12 together and to close off two ends of a hydraulic manifold 16a (described below) of the spraying device 16.

The wiper blade 10 is configured to wipe the glazed surface 20 of the automotive vehicle 2. It is generally made of elastomer and is held along its entire length. The windshield wiper 1 is generally fastened to a drive arm 3, illustrated in FIG. 1, which is driven in an angular back and forth movement by a motor. The wiper blade 10 is thus configured to wipe the glazed surface 20 by scraping it during these angular back and forth movements, thereby making it possible at the same time to remove washer fluid L by carrying it out of the field of view of the driver of the automotive vehicle 2.

The stiffening member 11 with the vertebra support 12.1 and said at least one vertebra 12 make it possible to stiffen the wiper blade 10 so as to promote the application of the wiper blade 10 to the glazed surface 20. The stiffening member 11 distributes the bearing force on the drive arm 3 along the wiper blade 10. It thus makes it possible to transfer the pressure of the drive arm 3 by distributing it along the length of the windshield wiper 1. Said at least one vertebra 12 is a longitudinal vertebra. It comprises a radius of curvature. It is therefore not flat. Moreover, the vertebra 12 is bent and its bend makes it possible to give a curved shape to the wiper blade 10 while keeping it pressed against the glazed surface 10. In other words, it is the vertebra 12 which brings about the curvature of the wiper blade 10. The stiffening member 11 thus ensures that the wiper blade 10 follows the curved shape of the glazed surface 20 such as the windshield of the automotive vehicle 2 in the nonlimiting example given. In one nonlimiting embodiment, the vertebra 12 is metallic. This makes it possible to stiffen and curve the wiper blade 10. The vertebra support 12.1 is configured to support said at least one vertebra 12 and the wiper blade 10.

In one nonlimiting embodiment, the stiffening member 11 comprises two vertebrae 12. The vertebra support 12.1 is thus configured to support the two vertebrae 12. They are placed end to end via their longitudinal ends. In one nonlimiting embodiment, the two vertebrae 12 have different radii of curvature from one vertebra 12 to the other, making it possible to apply different forces along the wiper blade 10. In one nonlimiting embodiment variant, a first vertebra 12, referred to as lower vertebra 12, is flatter than the second vertebra 12, referred to as upper vertebra 12, which is more curved. The lower vertebra 12 is the one that is closest to the drive arm 3. In one nonlimiting embodiment, the two vertebrae 12 have different lengths. In one nonlimiting embodiment variant, the lower vertebra 12 is longer than the upper vertebra 12, which is shorter. In one nonlimiting embodiment, the two vertebrae 12 are aligned in the vertebra support 12.1.

The central mount 13 is configured to be fastened to the drive arm 3. The central arm 13 is joined via a central pivot (not illustrated) to an end part 30 (illustrated in FIG. 1) of the drive arm 3. In one nonlimiting embodiment, the drive arm 3 comprises the end part 30, which is crimped onto a rod 31 connected to a casing 32. The end part 30 thus serves as a connection between the rod 31 and the central mount 13. In one nonlimiting exemplary embodiment, the central pivot is configured to bring about a rotation of plus or minus 15° between the windshield wiper 1 and the drive arm. In another nonlimiting embodiment, the drive arm 3 comprises an end part 30 which is in one piece with the casing 32. There is no rod 31 in that case.

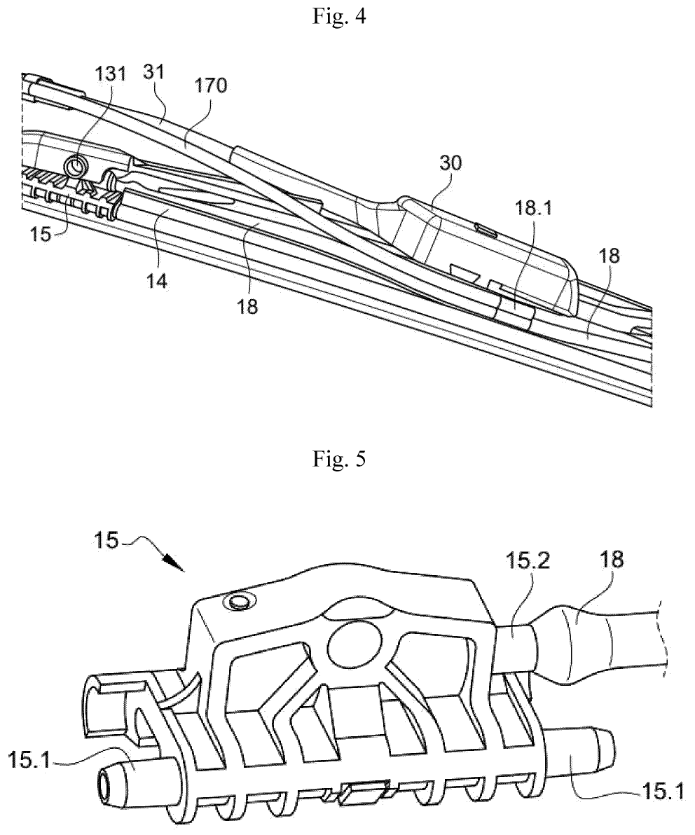

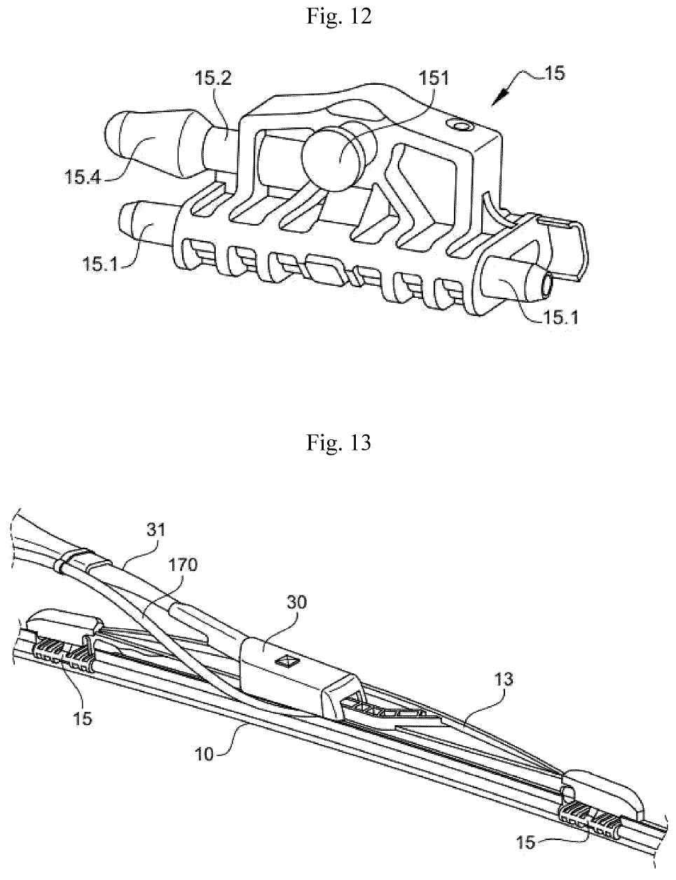

In one nonlimiting embodiment, the central mount 13 is articulated on each of the connectors 15 via a pivot connection. The pivot connection extends perpendicularly to the longitudinal axis of the windshield wiper 1. In one nonlimiting example, the pivot connection is realized by the cooperation between a pin 151 (illustrated in FIG. 1 or FIG. 12, for example) protruding laterally from either side of the connector 15, and an opening 131 (illustrated in FIG. 4, for example) in the central mount 13, configured to receive said pin 151. The pivot connection allows the central mount 13 to rotate with respect to the connector 15 in a plane perpendicular to the plane of rotation of the windshield wiper 1. Having two connectors 15 makes it possible to better distribute the pressure force locally on the vertebrae 12.

In one nonlimiting embodiment, the central mount 13 comprises an air deflecting surface 130. This air deflecting surface 130 makes it possible to convert the aerodynamic forces brought about on the windshield wiper 1 into a downforce which will press said windshield wiper 1 onto the glazed surface 20 and will ensure effectiveness of wiping and washing at high speed. The central mount 13 is also configured to hold the two connectors 15.

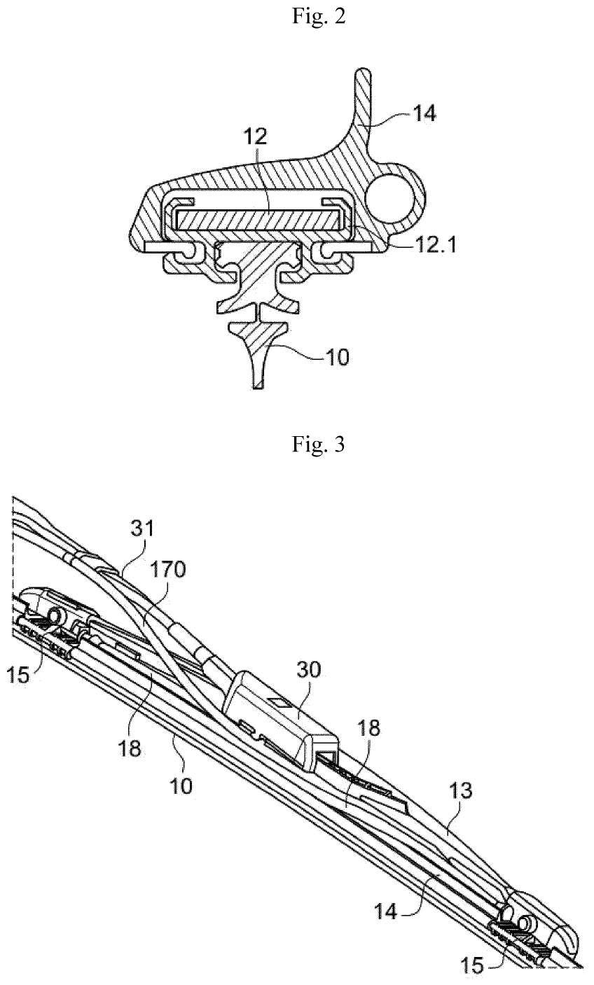

The air deflector 14 is an aerodynamic deflector which uses the relative wind of the automotive vehicle 2 to increase the force of contact of the wiper blade 10 with the glazed surface 20 to be wiped. As illustrated in FIG. 1, in one nonlimiting embodiment, the air deflector 14 is made up of at least three parts. Thus, it comprises a lower part 14.1, also referred to as bottom part 14.1, a central part 14.2, and an upper part 14.3, also referred to as top part 14.3. The lower part 14.1 extends from the lower end 1.1 of the windshield wiper 1 to a first connector 15. The central part 14.2 is situated between the two connectors 15. The upper part 14.3 extends from the second connector 15 to the upper end 1.2 of the windshield wiper 1. The cross section in FIG. 2 illustrates some of the elements of the windshield wiper 1 according to one nonlimiting embodiment. The shape of the air deflector 14, a vertebra 12 which makes it possible to apply a force to the wiper blade 10, and a vertebra support 12.1 can be seen. The air deflector 14 is connected to the vertebra support 12.1 in order to mechanically hold it and to the hydraulic channels 15.1 (described below) for the hydraulic function of distributing the washer fluid L. More particularly, the air deflector is fastened to an upper part of the vertebra support 12.1 so as to encapsulate the vertebra 12.

The connectors 15 are at a distance from one another and the central mount 13 is articulated on each of the connectors 15. A connector 15 is associated with a vertebra 12. Each connector 15 is secured to a vertebra 12. Each connector 15 is positioned substantially at the center of each vertebra 12. Thus, the pressure force exerted by the drive arm 3 connected to the central mount 13 is distributed over the two connectors 15, making it possible to distribute the pressure force uniformly along the wiper blade 10 via the stiffening member 11. The pressure force exerted is a force perpendicular to the plane of the windshield wiper 1. Specifically, on account of the curvature of the windshield wiper 10, and since the central mount 13 is articulated on at least two connectors 12 that are at a distance from one another, the pressure force exerted on the central mount 13 by the drive arm 3 is divided by two. The two connectors 15 thus each transmit half the pressure force exerted by the drive arm 3 to the wiper blade 10, in particular via the stiffening member 11 and each vertebra 12. Note that each connector 15 is disposed longitudinally at the center or substantially at the center of the vertebra 12 to which it is fastened. Half of the pressure force is therefore transmitted to the center, longitudinally, of each of the vertebrae 12 of the stiffening member 11. Thus, the pressure force of the drive arm 3 is distributed uniformly along the wiper blade 10 via the connectors 15 and the stiffening member 11. In particular, the pressure force is applied to the vertebrae 12 such that they transmit a constant force onto the glazed surface 20 of the automotive vehicle 2.

Since the vertebrae 12 have a curvature, when they are placed on the glazed surface 20, they are constrained thereby on the glazed surface 20. In response, a uniform pressure distribution exists since the force is applied at each center of each vertebra 12 by virtue of the two connectors 15. The two connectors 15 make it possible to have two connection points on the wiper blade 10 and the stiffening member 11, thereby avoiding the need for a lateral clearance at the ends of the wiper blade 10, referred to as sculling, which arises when there is only one connector 15 and therefore one connection point. With only one connection point, too much force is applied to this connection point, thereby creating the sculling. Sculling is a lateral movement which creates vibrations on the glazed surface 20, and consequently noise. Thus, by virtue of the two connectors 15, these vibrations are avoided and, consequently, the noise is eliminated. It will be noted that this lateral movement increases with the length of the wiper blade 10, in particular when it has a length equal to 1 m in one nonlimiting example.

It will also be noted that the two connectors 15 make it possible to follow the curvature of the glazed surface 20 more effectively than with a single connector 15. To this end, they are connected together via secondary pivots (not illustrated). The secondary pivots allow angular displacement of between plus or minus 5 degrees with respect to the longitudinal plane of the windshield wiper 1. This allows sufficient contact between the wiper blade 10 and the glazed surface 20. This makes it possible to have more effective cleaning, in particular in the case of a panoramic glazed surface 20. Specifically, in this case, the end of the windshield wiper 1 follows the end of the glazed surface 20. Thus, by virtue of the two connectors 15, cleaning is more effective, and there is no risk of the driver's view being disrupted.

By virtue of the two connectors 15 and of the vertebrae 12, pressure will be exerted along the entire length of the windshield wiper 1. The distribution of the force to the two vertebrae 12 is improved. The quality of wiping is maintained compared with a windshield wiper 1 which comprises only one vertebra 12 and one connector 15.

The spraying device 16 is configured to spray washer fluid L onto the glazed surface 20 and more particularly along the entire length of the windshield wiper. It comprises spray orifices 160. In one nonlimiting embodiment, the spraying device 16 comprises at least one hydraulic manifold 16a, also referred to as spray manifold 16a. In one nonlimiting embodiment, said at least one hydraulic manifold 16a comprises spray orifices 160 in at least one portion, which are configured to allow the washer fluid L to be sprayed.

In one nonlimiting embodiment, the hydraulic manifold 16a has a substantially cylindrical shape. In one nonlimiting embodiment, the spraying device 16 only comprises one hydraulic manifold 16a, which extends along one side of the windshield wiper 1. It is therefore a single-manifold device. In another nonlimiting embodiment, the spraying device 16 comprises two hydraulic manifolds 16a, which extends along each side of the windshield wiper 1. It is therefore a dual-manifold device. The combined action of the spraying of the washer fluid L and the sweeping movement of the wiper blade 10 makes it possible to eliminate certain particles that may stick to the glazed surface 20, such as splashes of mud, dust, squashed insect residues in nonlimiting examples.

The distribution device 17 for the washer fluid L is configured to distribute said washer fluid L to the spraying device 16. The distribution device 17 comprises a supply pipe 170. The latter is connected to the drive arm 3 and connects the windshield wiper 1 to a pump (not illustrated) connected to a tank (not illustrated) of washer fluid L situated generally under the hood of the automotive vehicle 2. Thus, the supply pipe 170 supplies the spraying device 16 with washer fluid L.

Various embodiments of the windshield wiper 1 are described below.

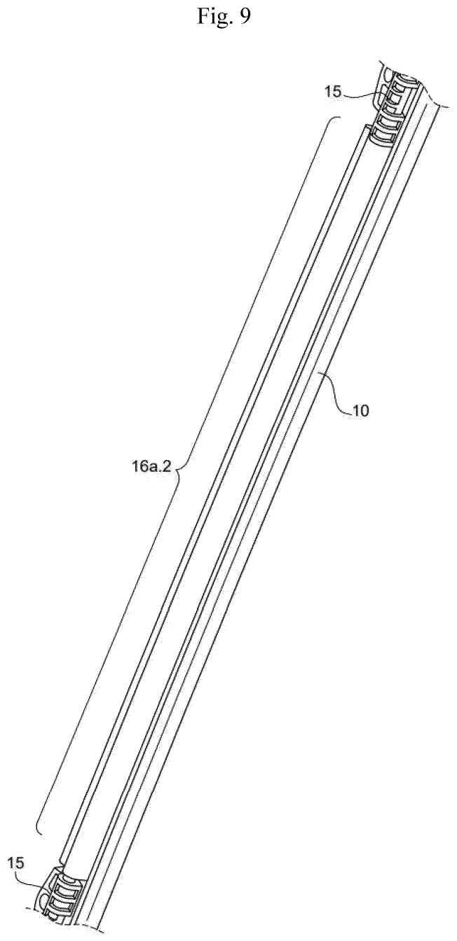

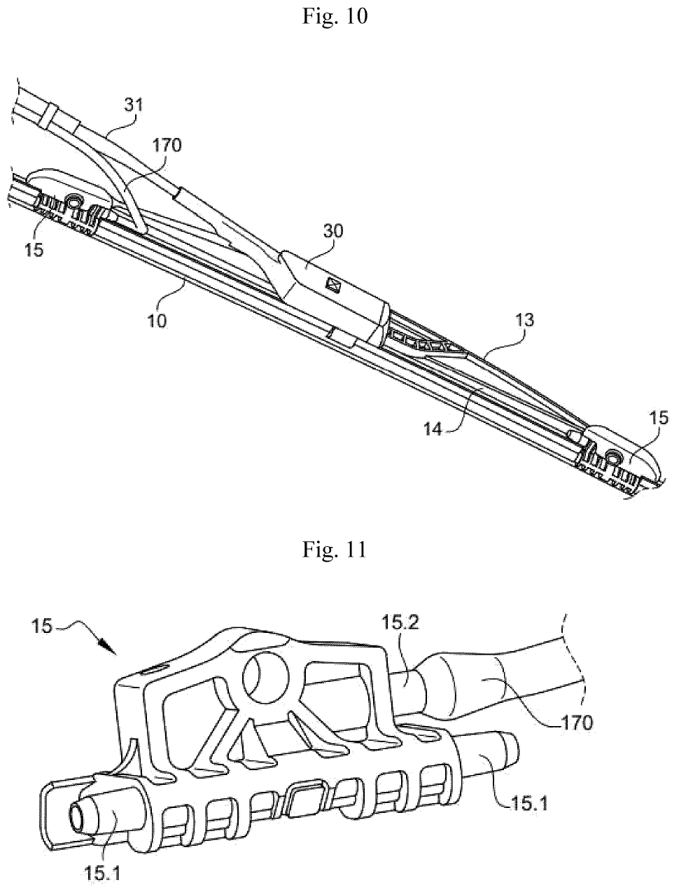

According to a first nonlimiting embodiment illustrated in FIG. 3 and FIG. 10, the air deflector 14 ensures the function of sprinkling. It will be noted that in this first nonlimiting embodiment, the central mount 13 does not ensure the function of sprinkling. It plays no part in spraying the washer fluid L onto the glazed surface 20. Thus, it has no spray orifices 160.

To this end, according to this first nonlimiting embodiment illustrated in FIGS. 3 and 10, the distribution device 17 comprises the supply pipe 170, which is connected to at least one of the two connectors 15 and the air deflector 14 comprises the spraying device 16. Thus, the air deflector 14 comprises said at least one hydraulic manifold 16a of the spraying device 16 and the supply pipe 170 is connected to said at least one hydraulic manifold 16a of the air deflector 14 via at least one of the two connectors 15.

The supply pipe 170 is connected indirectly or directly to at least one connector 15. Thus, said at least one connector 15 is configured to feed the washer fluid L to said at least one hydraulic manifold 16a of the spraying device 16.

The embodiment of a single hydraulic manifold 16a in the spraying device 16 is given as a nonlimiting example below.

According to a first nonlimiting embodiment variant illustrated in FIG. 3, the supply pipe 170 is connected to the two connectors 15 via, respectively, two feed pipes 18 for the washer fluid L. These feed pipes 18 are thus each connected, respectively, to said supply pipe 170 and to each connector 15. In other words, the windshield wiper 1 comprises two feed pipes 18 for the washer fluid L, which are each connected, respectively, to said supply pipe 170 and to each connector 15. In this case, each connector 15 feeds the washer fluid L directly to the air deflector 14, in particular into the hydraulic manifold 16a. As can be seen in FIG. 4, the two feed pipes 18 are connected to the supply pipe 170 via a hydraulic connector 18.1. The hydraulic connector 18.1 thus comprises one inlet and two outlets.

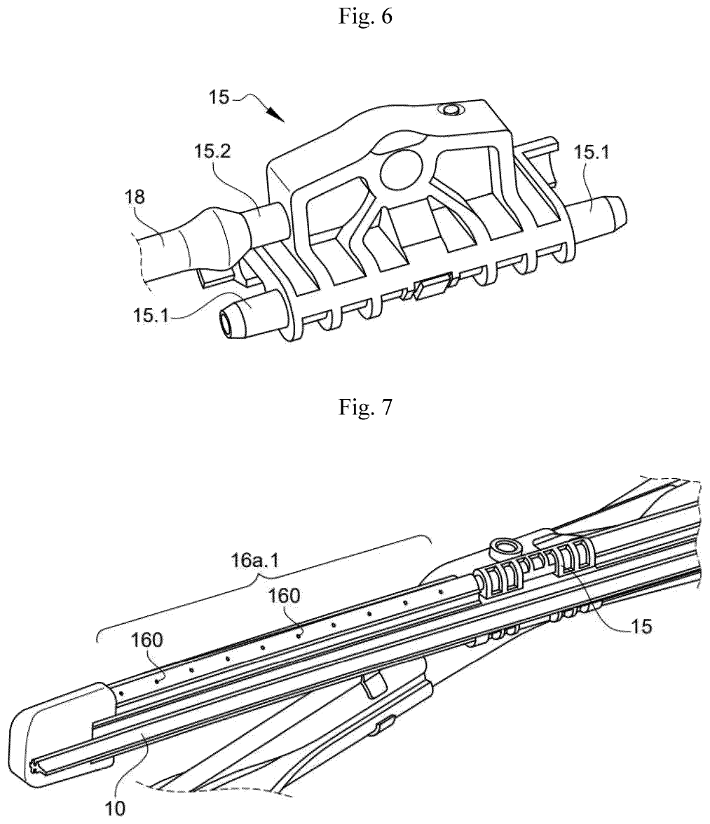

As illustrated in FIGS. 5 and 6, each connector 15 is connected to a feed pipe 18. FIG. 5 illustrates a first connector 15, also referred to as lower connector 15 or bottom connector 15, and FIG. 6 illustrates a second connector 15, also referred to as upper connector 15 or top connector 15. The lower connector 15 is connected to a feed pipe 18, also referred to as lower feed pipe 18. The upper connector 15 is connected to a feed pipe 18, also referred to as upper feed pipe 18.

As illustrated in FIGS. 5 and 6, each connector 15 comprises a hydraulic channel 15.1 for supplying in each case at least one portion of said at least one hydraulic manifold 16a with washer fluid L. In one nonlimiting embodiment, the lower connector 15 comprises two hydraulic channels 15.1, namely:
another hydraulic channel 15.1 connected to the lower portion 16a.1 of the hydraulic manifold 16a and configured to feed the washer fluid L into said lower portion 16a.1,
a hydraulic channel 15.1 connected to the central portion 16a.2 of the hydraulic manifold 16a and configured to feed the washer fluid L into this central portion 16a.2.

In one nonlimiting embodiment, the upper connector 15 comprises two hydraulic channels 15.1, namely:
a hydraulic channel 15.1 configured to feed the washer fluid L into the upper portion 16a.3 of the hydraulic manifold 16a,
another hydraulic channel 15.1 connected to the central portion 16a.2 of the hydraulic manifold 16a and configured to feed the washer fluid L into this central portion 16a.2.

As illustrated in FIG. 5, the lower connector 15 also comprises a cannula 15.2 configured to be connected to the lower feed pipe 18. As illustrated in FIG. 6, the upper connector 15 also comprises a cannula 15.2 configured to be connected to the upper feed pipe 18.

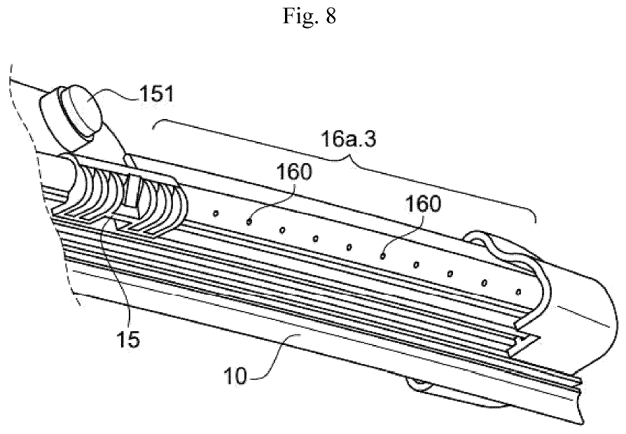

In one nonlimiting embodiment, the hydraulic manifold 16a comprises spray orifices 160 in two of its portions. The hydraulic manifold 16a comprises a lower portion 16a.1, also referred to as bottom portion 16a.1 (illustrated in FIG. 7), a central portion 16a.2 (illustrated in FIG. 9), and an upper portion 16a.3, also referred to as top portion 16a.3 (illustrated in FIG. 8).

In one nonlimiting embodiment, the lower portion 16a.1 and the upper portion 16a.3 comprise spray orifices 160. For reasons of conciseness, only some spray orifices 160 have been provided with reference signs in FIG. 7 and FIG. 8. In one nonlimiting embodiment, the central portion 16a.2 has no spray orifices 160.

The lower connector 15 is configured to feed the washer fluid L in particular to the lower portion 16a.1 of the hydraulic manifold 16a. The upper connector 15 is configured to feed the washer fluid L in particular to the upper portion 16a.3 of the hydraulic manifold 16a. It will be noted that although the two connectors 15 feed the washer fluid L into the central portion 16a.2 of the hydraulic manifold 16a, this central portion 16a.2 is not used for the spraying function since it does not comprise spray orifices 160. Of course, in another nonlimiting embodiment, each connector 15 may incorporate only one hydraulic channel 15.1 for supplying only one portion of the hydraulic manifold 16a which ensures the spraying function, namely a portion which has spray orifices 160.

Thus, according to this first nonlimiting embodiment variant, the washer fluid L is distributed at two points via the two connectors 15. This first nonlimiting embodiment variant allows good distribution of the washer fluid L in the windshield wiper 1.

According to a second nonlimiting embodiment variant illustrated in FIG. 10, the supply pipe 170 is connected directly to a single connector 15. In other words, the windshield wiper 1 does not comprise an intermediate feed pipe 18 for the washer fluid L. In this case, a single connector 15 distributes the washer fluid L directly to the air deflector 14, namely to the hydraulic manifold 16a. As can be seen in the nonlimiting example in FIG. 11, the supply pipe 170 is connected directly to a first connector 15, in this case the lower connector 15.

As in the case of the first nonlimiting embodiment variant, in one nonlimiting embodiment, the hydraulic manifold 16a comprises spray orifices 160 in two of its portions, namely the lower portion 16.1 and the upper portion 16.3.

Said single connector 15, in this case the lower connector 15, comprises a hydraulic channel 15.1 for supplying at least one portion 16.1 of said at least one hydraulic manifold 16a with washer fluid L.

As illustrated in FIG. 11, the lower connector 15 is thus configured to feed the washer fluid L into the lower portion 16a.1, into the central portion 16a.2, and also into the upper portion 16a.3 of the hydraulic manifold 16a. Thus, the lower connector 15 comprises two hydraulic channels 15.1, namely:
a hydraulic channel 15.1 connected to the lower portion 16.1 of the hydraulic manifold 16a and configured to feed the washer fluid L into this lower portion 16a.1,
another hydraulic channel 15.1 connected to the central portion 16a.2 of the hydraulic manifold 16a and configured to supply the central portion 16.2 and the upper portion 16a.3 of the hydraulic manifold 16a with washer fluid L.

It will be noted that in this case, a sufficiently powerful pump (not illustrated) is required to feed the washer fluid L into the upper portion 16a.3, said pump being situated under the hood of the automotive vehicle 2 and connected to the tank.

In one nonlimiting embodiment, the lower connector 15 also comprises a cannula 15.2 configured to be connected, this time, directly to the supply pipe 170.

FIG. 12 illustrates a second connector 15, referred to as upper connector. The upper connector 15 comprises two hydraulic channels 15.1, which are connected respectively to the central portion 16a.2 and to the upper portion 16a.3 of the hydraulic manifold 16a. The two hydraulic channels 15.1 are configured to pass the washer fluid L which has been fed into the central portion 16a.2 through the lower connector 15 from the central portion 16a.2 to the upper portion 16a.3 of the hydraulic manifold 16a. The washer fluid L thus passes from one portion of the hydraulic manifold 16a to another portion via the hydraulic channels 15.1. In particular, the washer fluid L passes from the central portion 16a.2 to the upper portion 16a.3 via the two hydraulic channels 15.1 of the upper connector 15.

In one nonlimiting embodiment, the upper connector 15 has no inlet for washer fluid L. To this end, in one nonlimiting embodiment variant, the upper connector 15 also comprises a cannula 15.2 configured to be closed with a plug 15.4. This prevents washer fluid L from escaping to the outside and this makes it possible to use one and the same standard part for the lower connector 15 and the upper connector 15.

Thus, according to this second nonlimiting embodiment variant, the washer fluid L is distributed at a single point via one of the two connectors 15, in this case the lower connector 15. Of course, in another nonlimiting embodiment, it may be the upper connector 15 which feeds the washer fluid L to the lower portion 16.1, to the central portion 16.2 and to the upper portion 16.3 of the hydraulic manifold 16a. In this case, the supply pipe 170 is connected directly to this upper connector 15.

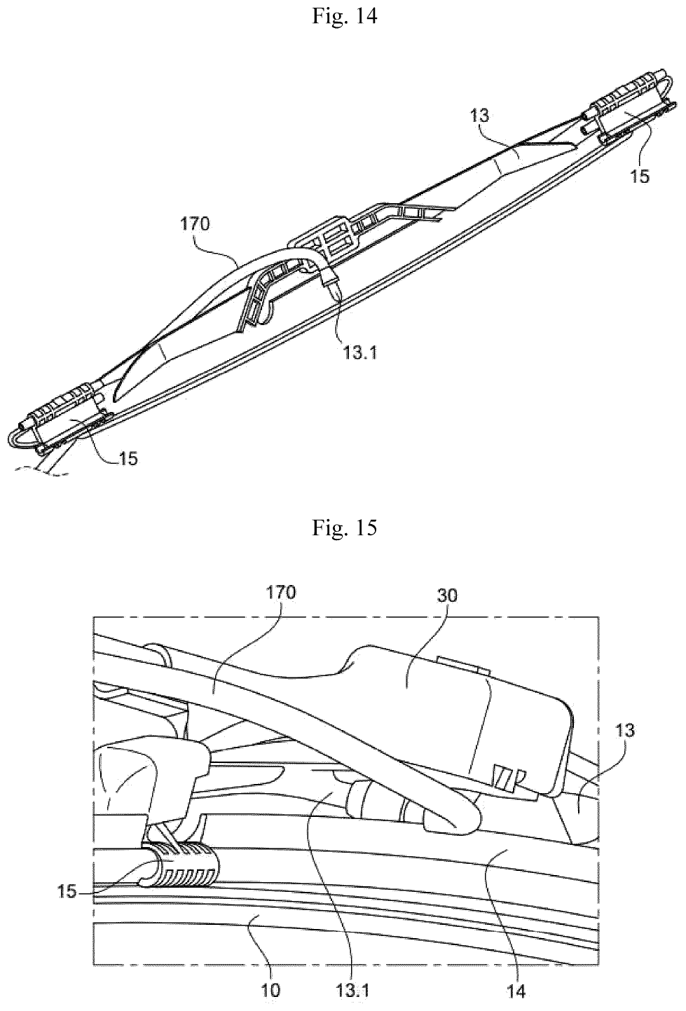

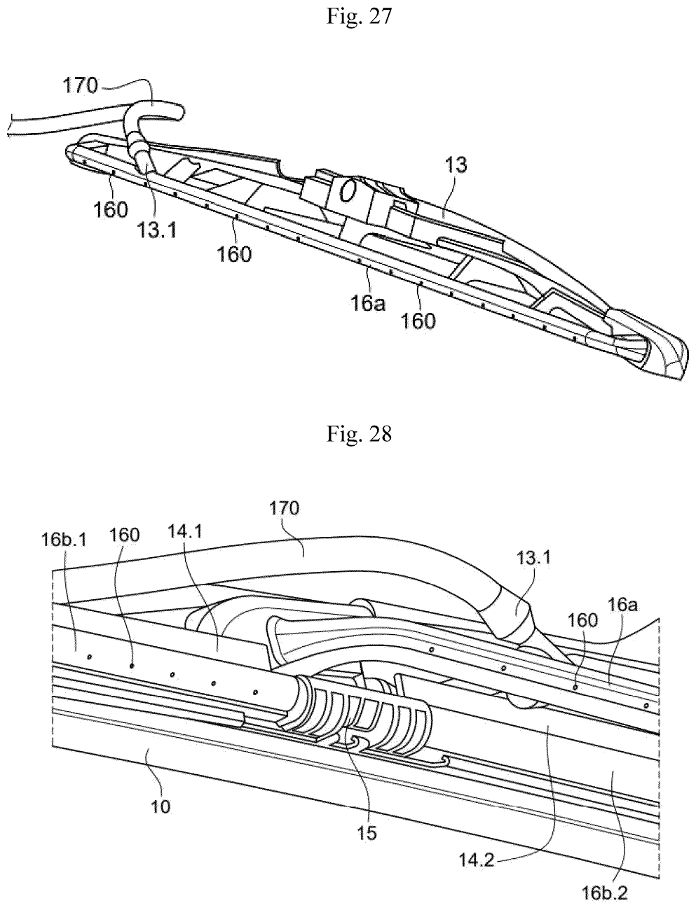

According to a second nonlimiting embodiment, the central mount 13 ensures all or part of the function of spraying washer fluid L onto the glazed surface 20. To this end, according to this second nonlimiting embodiment illustrated in FIG. 13 to FIG. 28, the distribution device 17 comprises a supply pipe 170 connected to said central mount 13 and the central mount 13 comprises all or part of the spraying device 16. As illustrated in the bottom view in FIG. 14 and the close-up view in FIG. 15, and in the close-up view in FIG. 21 and in FIG. 27, the supply pipe 170 is connected to the central mount 13 via a cannula 13.1.

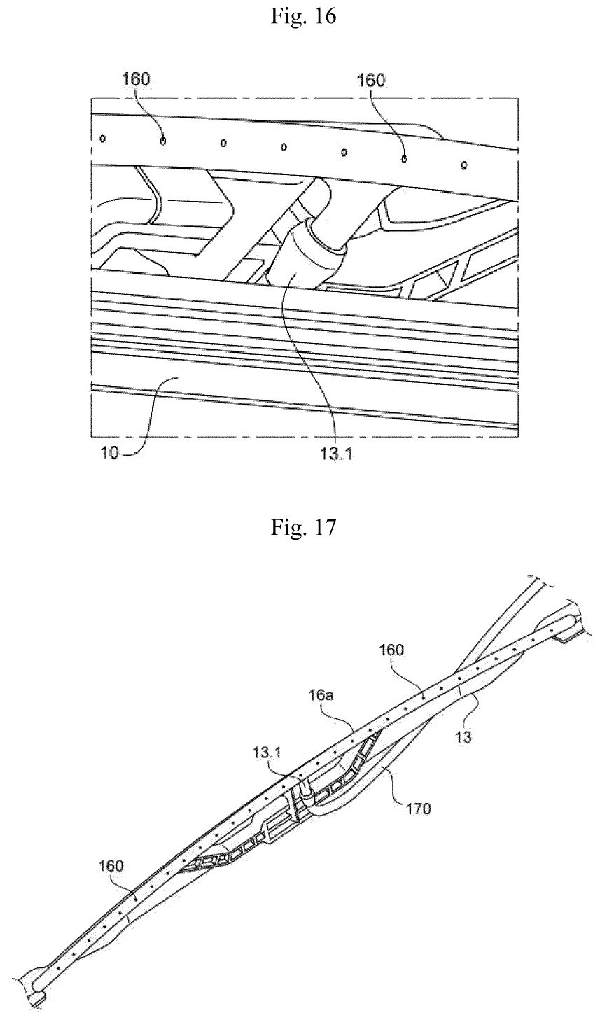

According to a first nonlimiting embodiment variant illustrated in FIG. 13 to FIG. 17, the central mount 13 ensures the entire function of spraying. To this end, the central mount 13 comprises the entire spraying device 160. Thus, as illustrated in FIG. 16 and FIG. 17, the central mount 13 comprises at least one hydraulic manifold 16a, which comprises the spray orifices 16. For reasons of conciseness, only some spray orifices 160 have been provided with reference signs in FIG. 16 and FIG. 17. As illustrated in FIG. 17, in one nonlimiting embodiment, said at least one hydraulic manifold 16a comprises spray orifices 160 along its entire length. This makes it possible to spray the washer liquid L via all the portions 16.1, 16.2 and 16.3 of the hydraulic manifold 16a along its entire length.

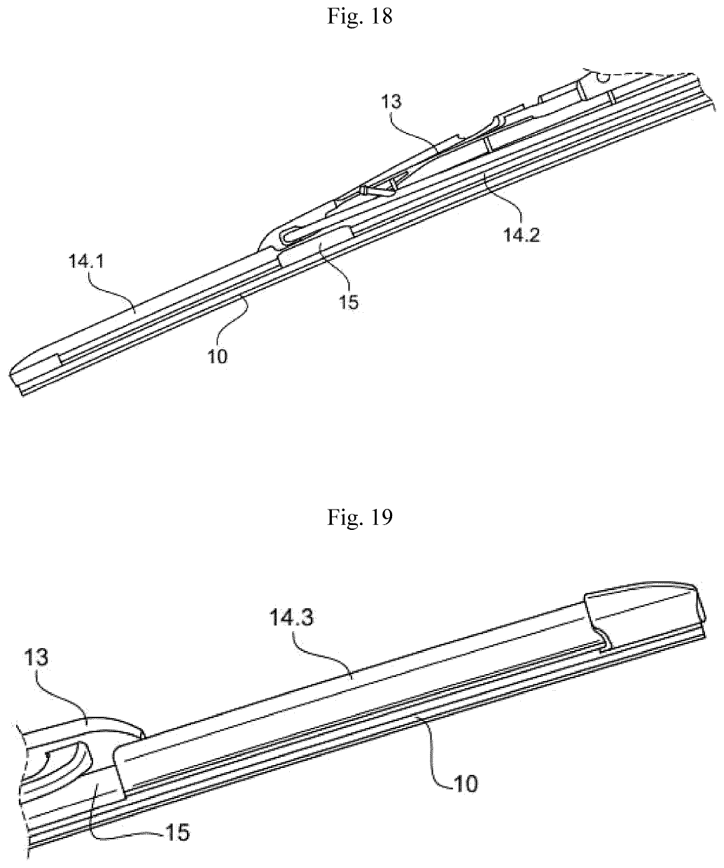

As illustrated in FIG. 18 and FIG. 19, the air deflector 14 does not comprise any spray orifices 160 either in its lower part 14.1 (illustrated in FIG. 18), in its central part 14.2 (illustrated in FIG. 18) or in its upper part 14.3 (illustrated in FIG. 19). It therefore does not ensure the function of spraying.

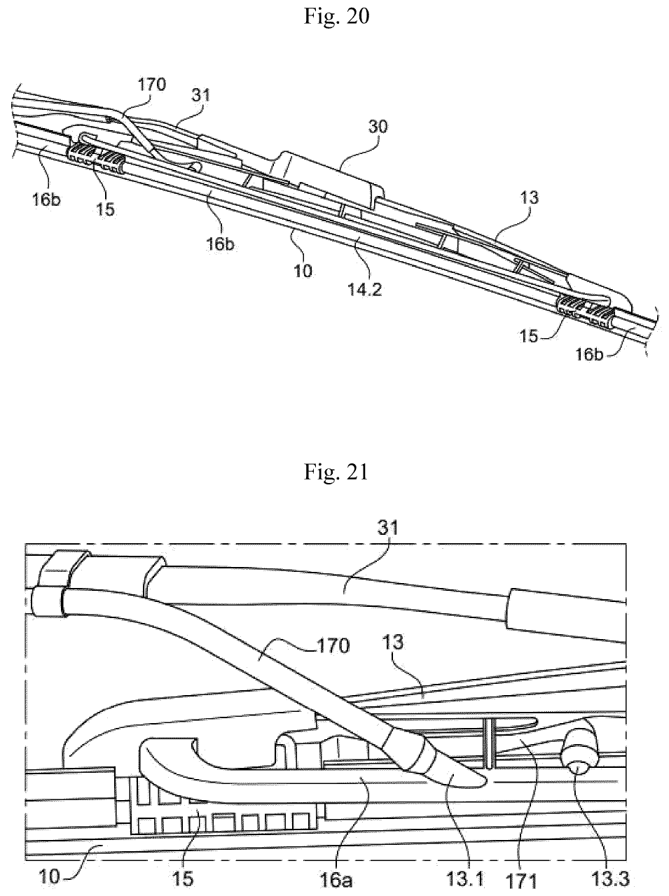

According to a second nonlimiting embodiment variant illustrated in FIG. 20 to FIG. 28, the central mount 13 ensures a part of the function of spraying, and the air deflector 14 ensures a part of the function of spraying. Thus, the central mount 13 comprises a part of the spraying device 16 and the air deflector 14 comprises a part of the spraying device 16. The spraying device 16 comprises at least one primary hydraulic manifold 16a that forms part of the central mount 13, and at least one secondary hydraulic manifold 16b that forms part of the air deflector 14.

In a first embodiment illustrated in the figures of this second nonlimiting embodiment variant, the spraying device 16 comprises one primary hydraulic manifold 16a that forms part of the central mount 13, and one secondary hydraulic manifold 16b that forms part of the air deflector 14. In one nonlimiting embodiment, the primary hydraulic manifold 16a and the secondary hydraulic manifold extend 16b on the same side of the windshield wiper 1. There is thus a single-manifold central mount 13 and a single-manifold air deflector 14.

In a second nonlimiting embodiment, which is not illustrated, of this second nonlimiting embodiment variant, said spraying device 16 comprises two primary hydraulic manifolds 16a and two secondary hydraulic manifolds 16b, and the supply pipe 170 is connected to the central mount 13 configured to feed the washer fluid L to the two secondary hydraulic manifolds 16b of the air deflector 14 via, respectively, the two connectors 15. There is thus a central mount 13 referred to as a dual-manifold central mount. There is thus also an air deflector 14 referred to as a dual-manifold air deflector. This makes it possible to enhance the washing of the glazed surface 20. The two primary hydraulic manifolds 16a each extend along each side of the central mount 13, and the two secondary hydraulic manifolds 16b each extend along each side of the air deflector 14.

In one nonlimiting embodiment, the two primary hydraulic manifolds 16a are activated alternately depending on the movement of the windshield wiper 1. This makes it possible to reduce the time for cleaning the glazed surface 20 and thus to improve the effectiveness of washing by spraying more washer fluid L. Activation means that a primary hydraulic manifold 16a sprays the washer fluid L onto the glazed surface 20. When it is deactivated, the washer fluid L is not sprayed. Thus, when the movement of the windshield wiper 1 is upward, one primary hydraulic manifold 16a is activated, whereas when the movement of the windshield wiper 1 is downward, the other primary hydraulic manifold 16a is activated. The same goes for the secondary hydraulic manifolds 16b. In one nonlimiting embodiment, the two secondary hydraulic manifolds 16b are activated alternately depending on the movement of the windshield wiper 1. This makes it possible to reduce the time for washing the glazed surface 20. Activation means that the secondary hydraulic manifold 16b sprays the washer fluid L onto the glazed surface 20. When it is deactivated, the washer fluid L is not sprayed. Thus, when the movement of the windshield wiper 1 is upward, one secondary hydraulic manifold 16b is activated, whereas when the movement of the windshield wiper 1 is downward, the other secondary hydraulic manifold 16b is activated.

The single-manifold central mount and the single-manifold air deflector 14 are given as a nonlimiting example in the remainder of the description.

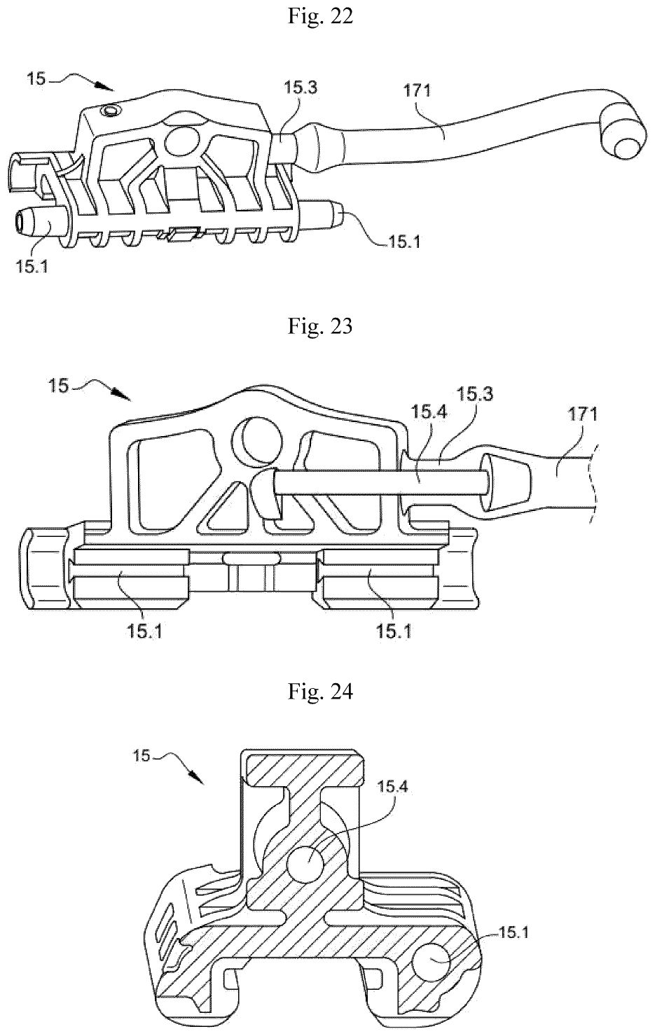

Furthermore, as illustrated in FIG. 21 and FIG. 22, said distribution device 17 also comprises a feed pipe 171 connected to the central mount 13 and to at least one of the two connectors 15. In the nonlimiting example illustrated in FIG. 21 to FIG. 24, this connector 15 is the lower connector 15. Thus, the washer fluid L is distributed in said secondary hydraulic manifold 16b by virtue of said lower connector 15. Thus, the central mount 13 feeds the washer fluid L to said secondary hydraulic manifold 16b of the air deflector 14 via the lower connector 15.

In other words, as illustrated in FIG. 21 and FIG. 27, the central mount 13 comprises said at least one primary hydraulic manifold 16a, which comprises spray orifices 160. For reasons of conciseness, only some spray orifices 160 have been provided with reference signs in the figures. As illustrated in FIG. 27, in one nonlimiting embodiment, said at least one hydraulic manifold 16a comprises spray orifices 160 along its entire length. This makes it possible to spray the washer liquid L via all the portions 16a.1, 16a.2 and 16a.3 of the primary hydraulic manifold 16a along its entire length.

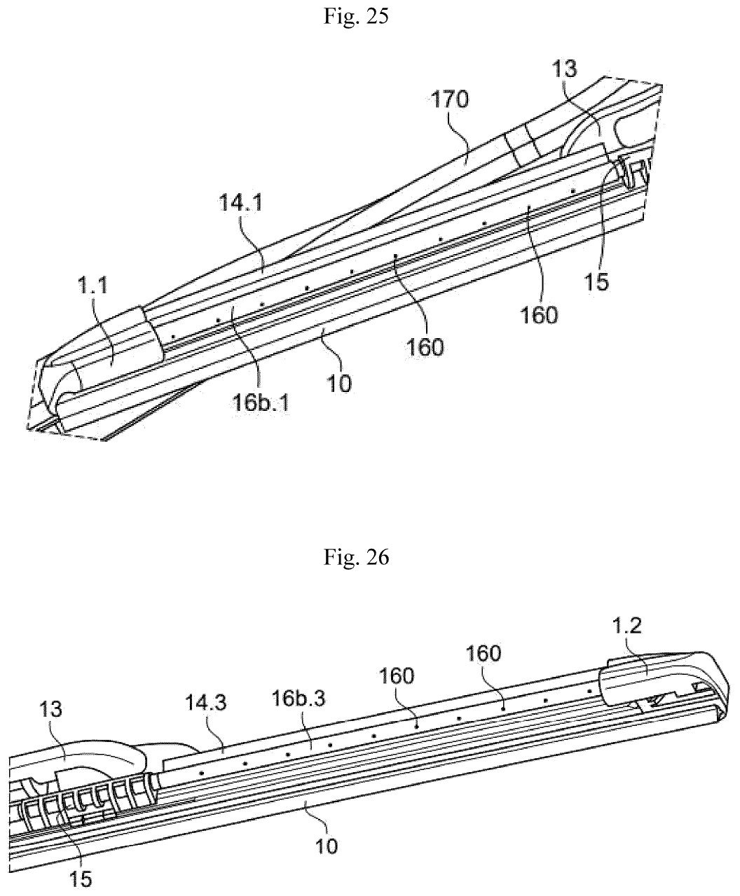

In other words, as illustrated in FIG. 21, FIG. 25 and FIG. 26, said air deflector 14 comprises said at least one secondary hydraulic manifold 16b, which comprises spray orifices 160. For reasons of conciseness, only some spray orifices 160 have been provided with reference signs in the figures.

As illustrated in a close-up manner in FIG. 21, the supply pipe 170 is connected to the central mount 13 via a cannula 13.1. As illustrated in FIG. 22, the feed pipe 171 is connected to the connector 15 used to feed the washer fluid L into the secondary hydraulic manifold 16b via a cannula 15.3. As illustrated in FIG. 21, the feed pipe 171 is connected to the central mount 13 via a cannula 13.3. Thus, the washer fluid L passes from the central mount 13 to the connector 15 via this feed pipe 171.

As illustrated in the cross sections in FIG. 23 and FIG. 24, the cannula 15.3 is continued by a hydraulic channel 15.4 connected to at least one other hydraulic channel 15.1.

As illustrated in the cross sections in FIG. 22, FIG. 23 and FIG. 24, this other hydraulic channel 15.1 is configured to supply the secondary hydraulic manifold 16b with washer fluid L. Said at least one connector 15, in this case the lower connector 15, used to feed the washer fluid L thus comprises at least one hydraulic channel 15.1.

As illustrated in the nonlimiting example, the spraying device 16 comprises one secondary hydraulic manifold 16a and the supply pipe 170 is connected to the central mount 13 configured to feed the washer fluid L to the secondary hydraulic manifold 16b of the air deflector 14 via one of the two connectors 15. There is thus an air deflector 14 referred to as a single-manifold air deflector.

Thus, as illustrated in FIG. 25, the air deflector 14 comprises a first portion of secondary hydraulic manifold 16b, also referred to as lower portion 16b.1. As illustrated in FIG. 26, the air deflector 14 comprises a second portion of secondary hydraulic manifold 16b, also referred to as upper portion 16b.3. As illustrated in FIG. 25, the lower portion 16b.1 comprises spray orifices 160 which extend from the lower end 1.1 of the windshield wiper 1 to the lower connector 15. The lower portion 16b.1 is thus part of the lower part 14.1 of the air deflector 14. As illustrated in FIG. 26, the upper portion 16b.3 comprises spray orifices 160 which extend from the upper end 1.2 of the windshield wiper 1 to the upper connector 15. The upper portion 16b.3 is thus part of the upper part 14.3 of the air deflector 14. Thus, the lower portion 16b.1 makes it possible to spray the washer fluid L in the lower part of the windshield wiper 1, and the upper portion 16b.3 makes it possible to spray the washer fluid in the upper part of the windshield wiper 1. As illustrated in FIG. 22, said at least one connector 15 comprises a first hydraulic channel 15.1 configured to supply the lower portion 16b.1 of the secondary hydraulic manifold 16b with washer fluid L, and a second hydraulic channel 15.1 configured to supply the upper portion 16b.3 of the secondary hydraulic manifold 16b with washer fluid L.

It will be noted that in this nonlimiting embodiment variant, as illustrated in FIG. 28, the air deflector 14 comprises a central part 14.2 with a portion of secondary hydraulic manifold 16b.2 without spray orifices 160. Of course, in another nonlimiting embodiment variant, there may be a central portion 16b.2 of secondary hydraulic manifold 16b which comprises spray orifices 160.

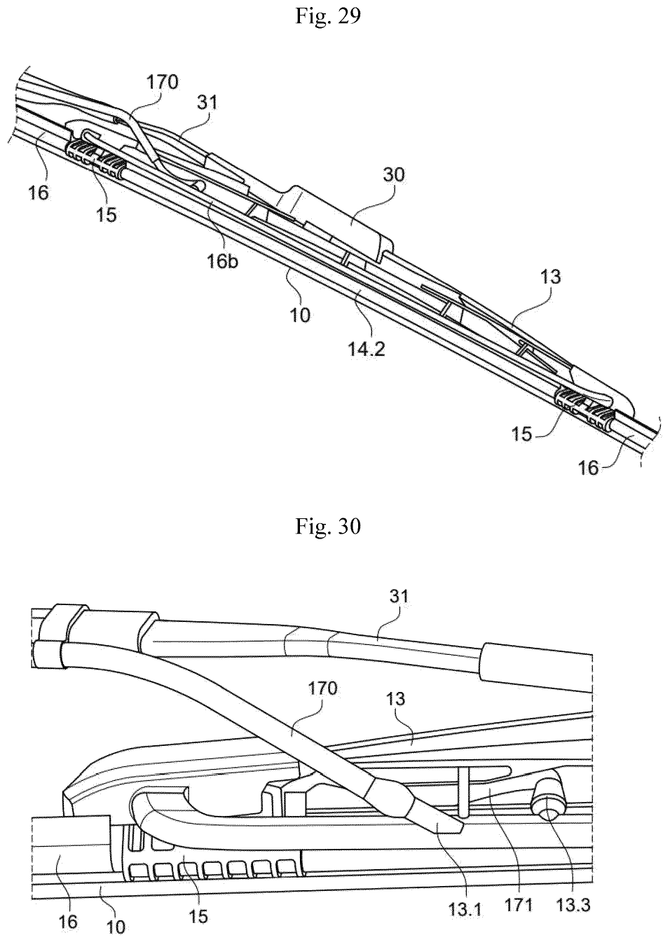

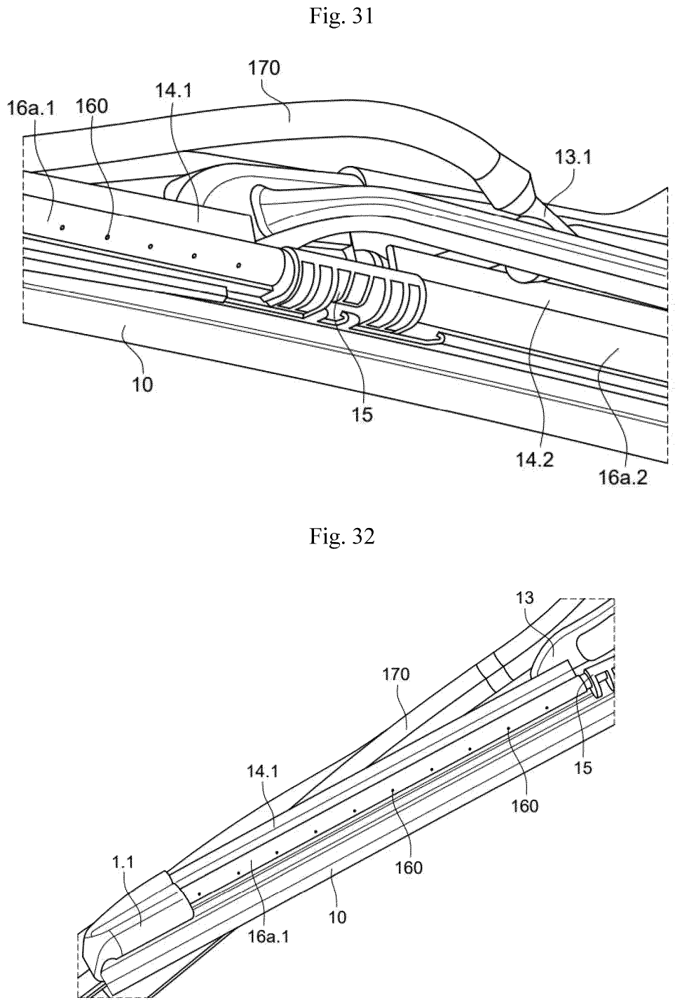

In a third nonlimiting embodiment illustrated in FIG. 29 to FIG. 34, the air deflector 14 ensures the entire function of sprinkling. In this case, the central mount 13 does not ensure the function of spraying. Thus, as illustrated in FIG. 30 and FIG. 31, the central mount 13 thus does not comprise any spray orifices 160. It will be noted that FIG. 22 to FIG. 24 also apply to this third nonlimiting embodiment, by replacing the reference sign 16b.1 with the reference sign 16.1 and 16b.3 with the reference sign 16.3.

To this end, said air deflector 14 comprises the spraying device 16 and said distribution device 17 comprises:
the supply pipe 170 connected to said central mount 13, and
a feed pipe 171 connected to the central mount 13 and to at least one of the two connectors 15.

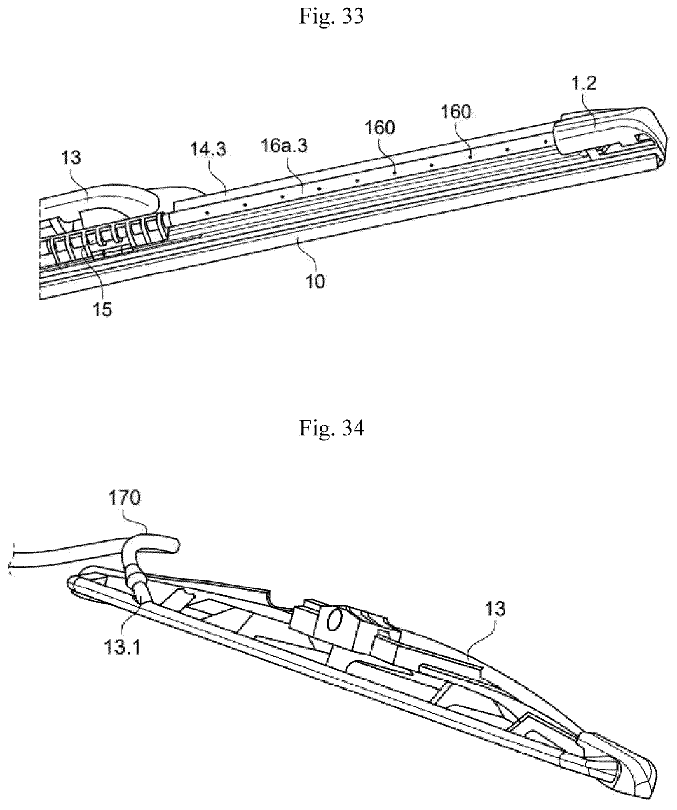

In other words, said air deflector 14 comprises at least one hydraulic manifold 16a, which comprises spray orifices 160 as illustrated in FIG. 31, FIG. 32 and FIG. 33.

In a first embodiment variant of this third embodiment illustrated in the figures, the spraying device 16 comprises one hydraulic manifold 16a that forms part of the air deflector 14, and the supply pipe 170 is connected to the central mount 13 configured to feed the washer fluid L to the hydraulic manifold 16a of the air deflector 14 via one of the two connectors 15. There is thus an air deflector 14 referred to as a single-manifold air deflector.

In a second embodiment variant, which is not illustrated, of this third embodiment, said spraying device 16 comprises two hydraulic manifolds 16a that form part of the air deflector 14, and the supply pipe 170 is connected to the central mount 13 configured to feed the washer fluid L to the two hydraulic manifolds 16a of the air deflector 14 via, respectively, the two connectors 15. There is thus also an air deflector 14 referred to as a dual-manifold air deflector. This makes it possible to enhance the washing of the glazed surface 20. The two hydraulic manifolds 16a each extend along each side of the air deflector 14. In one nonlimiting embodiment, the two hydraulic manifolds 16a are activated alternately depending on the movement of the windshield wiper 1.

The single-manifold air deflector 14 is given as a nonlimiting example in the remainder of the description.

Furthermore, as illustrated in FIG. 30, said distribution device 17 also comprises a feed pipe 171 connected to the central mount 13 and to at least one of the two connectors 15. In the nonlimiting example illustrated, this connector 15 is the lower connector 15. Thus, the washer fluid L is distributed in said at least one hydraulic manifold 16a by virtue of said lower connector 15. Thus, the central mount 13 feeds the washer fluid L to said hydraulic manifold 16a of the air deflector 14 via the lower connector 15.

As illustrated in a close-up manner in FIG. 30, the supply pipe 170 is connected to the central mount 13 via a cannula 13.1. As illustrated in FIG. 22, the feed pipe 171 is connected to the connector 15 used to feed the washer fluid L into the hydraulic manifold 16a via a cannula 15.3. As illustrated in FIG. 30, the feed pipe 171 is connected to the central mount 13 via a cannula 13.3. Thus, the washer fluid L passes from the central mount 13 to the connector 15 via this feed pipe 171.

As illustrated in the cross sections in FIG. 23 and FIG. 24, the cannula 15.3 is continued by a hydraulic channel 15.4 connected to at least one other hydraulic channel 15.1.

As illustrated in the cross sections in FIG. 22, FIG. 23 and FIG. 24, this other hydraulic channel 15.1 is configured to supply the hydraulic manifold 16a with washer fluid L. Said at least one connector 15, in this case the lower connector 15, used to feed the washer fluid L thus comprises at least one hydraulic channel 15.1.

As illustrated in FIG. 32, the air deflector 14 comprises a first portion of hydraulic manifold 16a.1, also referred to as lower portion 16a.1. As illustrated in FIG. 33, the air deflector 14 comprises a second portion of hydraulic manifold 16a.3, also referred to as upper portion 16a.3. As illustrated in FIG. 32, the lower portion 16a.1 comprises spray orifices 160 which extend from the lower end 1.1 of the windshield wiper 1 to the lower connector 15. The lower portion 16a.1 is thus part of the lower part 14.1 of the air deflector 14. As illustrated in FIG. 33, the upper portion 16a.3 comprises spray orifices 160 which extend from the upper end 1.2 of the windshield wiper 1 to the upper connector 15. The upper portion 16a.3 is thus part of the upper part 14.3 of the air deflector 14. Thus, the lower portion 16a.1 makes it possible to spray the washer fluid L in the lower part of the windshield wiper 1, and the upper portion 16a.3 makes it possible to spray the washer fluid in the upper part of the windshield wiper 1. As illustrated in FIG. 22, said at least one connector 15 comprises a first hydraulic channel 15.1 configured to supply the lower portion 16a.1 of the hydraulic manifold 16a with washer fluid L, and a second hydraulic channel 15.1 configured to supply the upper portion 16a.3 of the hydraulic manifold 16a with washer fluid L.

It will be noted that in this nonlimiting embodiment variant, as illustrated in FIG. 31, the air deflector 14 comprises a central part 14.2 with a portion of secondary hydraulic manifold 16a.2 without spray orifices 160. Of course, in another nonlimiting embodiment variant, there may be a central portion 16a.2 of hydraulic manifold 16a which comprises spray orifices 160.

Of course, the description of the invention is not limited to the embodiments described above and to the field described above. Thus, in another nonlimiting embodiment of the second nonlimiting embodiment variant of the second nonlimiting embodiment, there may be a combination of a dual-manifold central mount and a single-manifold deflector, or vice versa. Thus, in another nonlimiting embodiment the stiffening member 11 comprises three vertebrae with three connectors that are connected together by intermediate mounts. In this case, the air deflector 14 is made up of more than three parts.

Thus, the invention that has been described notably has the following advantages:
it makes it possible to combine, in a single structure, a function of wiping and a function of washing with a washer fluid L by incorporating a spraying device 16 into the windshield wiper 1,
by virtue of the two connectors 15 and of the spraying device 16 incorporated into the windshield wiper 1, washing is more effective than in the prior art, which incorporates a spraying device in the region of the hood of the automotive vehicle 2,
it makes it possible to better follow the curve of the glazed surface 20 while it is being sprinkled with the washer fluid L,
it makes it possible to have a long windshield wiper 1 that is more robust,
it allows good distribution of the pressure force of the drive arm 3 on the windshield wiper 1. It therefore makes it possible to adapt to complex glazed surfaces 20 which have a very significant curvature, such as supercars, trucks, in nonlimiting examples in which the curvature of the glazed surface 20 is very pronounced,
it makes it possible to generate pressure on the end of the windshield wiper 1 in order to bear on the end of the glazed surface 20 and thus to follow the curvature for a small or large glazed surface 20, in particular for a panoramic windshield. Cleaning is consequently more effective,
it makes it easier to change the components of the windshield wiper 1 and to connect the supply pipe 170 by virtue of the different embodiments that are described.

What is claimed is:

1. A windshield wiper for a vehicle, the windshield wiper comprising:
at least one wiper blade configured to wipe a glazed surface of the vehicle,
a stiffening member comprising-including a vertebra support and at least one vertebra configured to stiffen the at least one wiper blade,
at least two connectors secured to the at least one vertebra,
a central mount articulated on each of the two connectors, the central mount being configured to be connected to a drive arm of the windshield wiper,
an air deflector connected to the vertebra support,
a spraying device configured to spray a washer fluid onto the glazed surface, the spraying device including spray orifices, and
a distribution device for the washer fluid, configured to distribute the washer fluid to the spraying device.

2. The windshield wiper as claimed in claim 1, wherein the spraying device comprises-includes at least one hydraulic manifold.

3. The windshield wiper as claimed in claim 2, wherein the at least one hydraulic manifold comprises-includes spray orifices in at least one portion of the at least one hydraulic manifold.

4. The windshield wiper as claimed in claim 1, wherein the distribution device comprises includes a supply pipe connected to at least one of the two connectors and the air deflector includes the spraying device.

5. The windshield wiper as claimed in claim 4, wherein the supply pipe is connected to the two connectors via two feed pipes for the washer fluid.

6. The windshield wiper as claimed in claim 4, wherein the supply pipe is connected directly to a single connector.

7. The windshield wiper as claimed in claim 4, wherein the at least one connector includes at least one hydraulic channel for supplying at least one portion of the spraying device with washer fluid.

8. The windshield wiper as claimed in claim 2, wherein the at least one hydraulic manifold of the spraying device includes spray orifices in two portions of the at least one hydraulic manifold.

9. The windshield wiper as claimed in claim 1, wherein the distribution device includes a supply pipe connected to the central mount.

10. The windshield wiper as claimed in claim 9, wherein the air deflector includes the spraying device and the distribution device also comprises includes a feed pipe connected to the central mount and to at least one of the two connectors.

11. The windshield wiper as claimed in claim 9, wherein the central mount includes all or part of the spraying device.

12. The windshield wiper as claimed in claim 11, wherein the air deflector includes a part of the spraying device, and the spraying device includes at least one primary hydraulic manifold that forms part of the central mount, and at least one secondary hydraulic manifold that forms part of the air deflector, and the distribution device also comprises-includes a feed pipe connected to the central mount and to at least one of the two connectors.

13. The windshield wiper as claimed in claim 12, wherein at least one of the two connectors includes a hydraulic channel for supplying the at least one secondary hydraulic manifold with washer fluid.

14. The windshield wiper as claimed in claim 1, wherein the stiffening member includes at least two vertebrae placed end to end via the vertebras longitudinal ends.
